(19) United States
(12) Patent Application Publication
(10) Pub. No.: US 2015/0310166 A1
(43) Pub. Date: Oct. 29, 2015

(54) METHOD AND SYSTEM FOR PROCESSING DATA FOR EVALUATING A QUALITY LEVEL OF A DATASET

(71) Applicants: INSTITUT NATIONAL DE LA SANTE ET DE LA RECHERCHE MEDICALE (INSERM), Paris (FR); CENTRE NATIONAL DE LA RECHERCHE SCIENTIFIQUE (C.N.R.S), Paris (FR); UNIVERSITÉ DE STRASBOURG, Strasbourg (FR)

(72) Inventors: Hinrich GRONEMEYER, ILLKIRCH (FR); Marco Antonio MENDOZA PARRA, LLKIRCH (FR)

(21) Appl. No.: 14/648,250

(22) PCT Filed: Nov. 26, 2013
(86) PCT No.: PCT/EP2013/074790

§ 371 Date: May 28, 2015

(30) Foreign Application Priority Data
Nov. 28, 2012 (EP) 12306478.4

(51) Int. Cl. G06F 19/22; G06F 17/30

(52) U.S. Cl. CPC G06F 19/22; G06F 17/30371

(57) ABSTRACT

A method processes data for evaluating quality level of an original dataset. The original dataset is obtained from an automated sequencing of a chain of nucleotides and represents a plurality of total mapped reads. The method includes sampling of a plurality of total mapped reads of the original dataset to produce a subset of mapped reads. The method also includes computing a dispersion indicator for the subset. The dispersion indicator represents divergence between an actual read count intensity and a theoretical read count intensity. The actual read count corresponds to the number of sampled mapped reads. The theoretical read count corresponds to a theoretical number of sampled mapped reads, which does not depend on the current sampling.

The invention relates to a method and a system for processing data for evaluating a quality level of an original dataset resulting from an automated sequencing of a chain of nucleotides.

The recent development of high throughput sequencing technologies, in particular next generation sequencing platforms (NGS platforms) has led to a rapid expansion of studies analyzing the genome-wide patterns of gene regulatory events and features, such as epigenetic DNA and histone modification, the binding patterns of transcription factors and their co-regulatory complexes, the patterns of post-translationally modified chromatin-associated factors and chromatin or transcription-modulatory multi-subunit machineries. Moreover, the mapping of transcriptomes by RNA-seq, GRO-seq or ribosome-associated (“ribosome footprinting”) RNAs, as well as technologies revealing chromatin conformation are also based on massive parallel sequencing (MPS).

A particular challenge is the comparison of multi-dimensional profiles for several factors, their post-translational modifications and/or chromatin marks.

However, studies performed in different settings, for example using different cells or antibodies, or performing sequencing at different depths or on different platforms, are not easily comparable, and even studies performed with the same cells in different laboratories can deviate extensively.

Indeed, a rather large number of factors can potentially influence the quality of NGS-based profilings.

Particularly, in the case of immunoprecipitation-based approaches (e.g., ChIP, MeDIP, GRO-seq, etc.), experimental parameters, like variable crosslinking efficiencies in different cell types or tissues, shearing or digestion of chromatin, or the selectivity and affinity of antibodies, can vary largely between experiments and different experimenters. These variations ultimately impact on the final readout, i.e. the distribution of the genome-mapped read counts.

In addition, different NGS platforms have largely different sequencing capacities, ranging from tens of millions (e.g. with the Illumina Genome analyzer v1, hereafter referred to as “GA1”) to more than 3 billion (e.g. with the Illumina HiSeq2000) of reads per flow cell. This results in very different sequencing depths making any comparison very difficult, if not impossible.

A major obstacle for the comparative analysis of genome-wide profilings generated by next generation sequencing is the absence of a quality control (QC) system which assess the quality and comparability of MPS-derived profiles, as well as the robustness of local features, such as peaks at particular loci, which are derived from the mapping of read-count intensities.

This concerns particularly multi-dimensional comparisons of global immunoprecipitated chromatin assays (ChIP-seq) aiming at correlating the patterns of chromatin marks, epigenetic and chromatin-modifying machineries, and polymerase II and transcription factor (TF) association, but also RNA profiling technologies.

Currently, the quality assessment is performed by visual inspection in a genome browser and/or by the capacity of peak/island/pattern caller algorithms to predict locally enriched sequence counts. In both cases, it is a rather subjective analysis relying on user-defined criteria, such as the choice of “representative” regions or thresholds for peak detection, and the statistical models and/or parameters used for assessment of enriched patterns.

In addition to visual inspection, analytical methods have been developed with the aim of providing quantitative quality assessments of NGS-generated profiles.

Methods like FRiP (fraction of mapped reads retrieved into peak regions) or IDR (irreproducibility discovery rate) require prior use of peak calling algorithms for evaluation and are therefore dependent on peak-calling performance of a given tool with the user-defined parameters. Consequently, they cannot be easily used for multi-profile comparisons when different peak callers are required. This is for example the case when transcription factor profiles are compared to epigenetic profiles that display broad RCI patterns. Note that the IDR approach can only be used when replicate profiles are available, which is strongly recommended but not a routine procedure. Furthermore, the criteria used for reproducibility by the IDR analysis can be misleading in cases where compared profiles present broad enrichment patterns.

Two other methods, signal distribution skewness and strand cross-correlation analysis (SCC) operate in a peak caller-independent manner. Signal distribution skewness evaluates the asymmetry of genome-wide tag count distribution, while SCC measures the quality of evaluated ChIP-seq profiles from the sequence tag density on forward and reverse strand reads at target sites.

SCC is thus applicable mainly, if not exclusively, to “sharp” patterns like those observed for transcription factor ChIP-seq datasets. It is evident that SCC cannot be used for quality assessment of broad patterns, as significantly enriched reads of such profiles cover large areas.

In the article “NGSQC: cross-platform quality analysis pipeline for deep sequencing data” published in BMC GENOMICS (Vol 11, no. suppl 4, December 2010) , Dai et al give an idea of a quality level evaluation of an original dataset resulting from an automated sequencing of a chain of nucleotides using a random sampling of the original dataset. However, the article does not disclose any efficient tool for a practical implementation of this idea. Moreover, the methodology presented in this document deals with the quality control (QC) of the sequencing process itself.

Importantly, at present there is no tool that provides quantitative measurements to reveal the quality of an entire NGS profile.

There is thus a need in the art for a quality control method allowing the quantitative characterization of the degree of technical similarity of the various data sets.

To address this need, the present inventors have developed a bioinformatics-based quality control system that uses raw NGS datasets to infer a set of global quality control indicators, which reveal the comparability of different NGS data sets, and to provide local quality control indicators to judge the robustness of cumulative read counts (“peaks or islands”) in a particular region.

Moreover, the system provides guidelines for the choice of the optimal sequencing depth for a given target and quantitative means of comparing different antibodies and antibody batches for ChIP-seq and related antibody-driven studies.

Thus, one aspect of the present invention relates to a method for processing data for evaluating a quality level of an original dataset resulting from an automated sequencing of a chain of nucleotides, wherein said sequenced chain comprises a plurality of predefined identified regions and said original dataset represents a plurality of total mapped reads and a plurality of read count intensities, each read count intensity corresponding to the number of total mapped reads in an identified region of said sequenced chain, said method being characterized in that it comprises the steps of:
sampling of the plurality of total mapped reads of said original dataset at a selected sampling density to produce at least one data subset comprising a plurality of sampled mapped reads;
for each said data subset computing at least one dispersion indicator for each of said identified regions, representative of the divergence between an actual read count intensity for said identified region in said data subset and a theoretical read count intensity for said identified region in said data subset, the actual read count intensity for said identified region corresponding to the number of sampled mapped reads in this identified region, the theoretical read count intensity for said identified region corresponding to a theoretical number of sampled mapped reads in this identified region which does not depend on the current sampling.

In the meaning of the present application, the term “actual read count intensity” signifies a number of sampled mapped reads in a given identified region for the current sampling.

In the meaning of the present application, the term “theoretical read count intensity” signifies a theoretical number of sampled mapped reads in a given identified region which does not depend on the current sampling.

In the meaning of the present application, the term “dispersion indicator” signifies any quantitative measure representative of the divergence between the read count intensity and the theoretical read count intensity for each identified region. Its expression is further detailed in the description.

In one embodiment, said theoretical read count intensity is computed on the basis of the read count intensity for said identified region in said original dataset and on the basis of said selected sampling density.

Said theoretical read count intensity may be computed as:

$$theoRCI = \frac{oRCI * samd}{100} ,$$

wherein:
the oRCI designates said theoretical read count intensity for said identified region in said original dataset,
samd designates said selected sampling density, expressed as a percentage between 0 and 100,
oRCI represents the read count intensity for said identified region in said original dataset.

In one embodiment, said dispersion indicator for an identified region is computed as:

$$\partial RCI = samd [ 1 - \frac{samRCI}{theoRCI} ] = samd - recRCI$$

$$with recRCI = \frac{samRCI}{oRCI} * 100 ,$$

wherein:
∂RCI said dispersion indicator, and
samRCI represents the actual read count intensity for said identified region in said data subset.

In a preferred embodiment, said or each data subset may be produced by randomly sampling said original dataset.

In one embodiment, said method further comprises the following steps:
determining a confidence subset of said identified regions for which the dispersion indicator is comprised within a given confidence interval, defined by a given maximal value,
computing a quality control density indicator representative of the robustness of said original dataset, on the basis of a comparison between the number of said identified regions in said confidence subset with the total number of identified regions.

Said quality control density indicator may be computed as a ratio between the number of said identified regions in said confidence subset and the total number of identified regions.

Said method may comprise the sampling of said original dataset for producing at least a first and a second data subset according to two distinct selected sampling densities and the computation, for each of said first and second data subsets, of the or each dispersion indicator for each identified region.

Said method may further comprise the step of computing a quality control similarity indicator based on the comparison between a quality control density of said first subset based on a first given confidence interval and a quality control density of said second subset based on a second given confidence interval.

In one embodiment, said first given confidence interval is identical to said second given confidence interval, and said quality control similarity indicator is computed as a ratio between the quality control density of said first subset and the quality control density of said second subset.

The method may further comprise the step of computing, for at least one given confidence interval, a quality control stamp based on:

(i) the quality control similarity indicator between said first and second data subsets, and

(ii) the quality control density indicator of one of said first and second data subsets.

Said control quality stamp may be computed as a ratio between the quality control density indicator of one said first and second subsets and the quality control similarity indicator between said first and second data subsets.

The method may further comprise the step of computing, for at least one given confidence interval, a quality grade representative of the robustness of the read count intensities in said original dataset as compared to a plurality of distinct datasets, said quality grade being based on a comparison between the quality control stamp associated with said original dataset for said given confidence interval and a set of quality control stamps associated with said plurality of distinct datasets for said given confidence interval.

The method may further comprise a background noise subtraction routine comprising a step of determining of a background noise level threshold value in the original dataset by using a given probability threshold, and a step of excluding any identified region presenting a read count intensity lower or equal to the background noise level threshold value.

The invention further relates to a system for processing data for evaluating a quality level of an original dataset resulting from an automated sequencing of a chain of nucleotides, wherein said sequenced chain comprises a plurality of predefined identified regions and said original dataset represents a plurality of total mapped reads and a plurality of read count intensities, each read count intensity corresponding to the number of total mapped reads in an identified region of said sequenced chain, said method being characterized in that it comprises the steps of:
means for sampling of the plurality of total mapped reads of said original dataset at a selected sampling density to produce at least one data subset comprising a plurality of sampled mapped reads;
means for computing, for each said data subset, at least one dispersion indicator for each of said identified regions, representative the divergence between an actual read count intensity for said identified region in said data subset and a theoretical read count intensity for said identified region in said data subset, the actual read count intensity for said identified region corresponding to the number of sampled mapped reads in this identified region, the theoretical read count intensity for said identified region corresponding to a theoretical number of sampled mapped reads in this identified region which does not depend on the current sampling.

The method according to the invention provides quantitative quality control indicators generated from the evaluation of a feature common to all NGS-generated profiles, namely the profile construction from sequenced read overlaps.

The original dataset results from an automated sequencing of a chain of nucleotides.

The expression “automated sequencing” refers to the process of reading the nucleotide bases in the chain of nucleotides, in order to determine the order of the four bases in this chain.

Said automated sequencing may include immuoprecipitation-based methods, such as Chromatin Immunoprecipitation-sequencing (ChIP-seq), Global Run-On Sequencing (GRO-seq) or Methylated DNA immunoprecipitation (MeDIP-seq), as well as other methods based on massive parallel sequencing such as RNA-sequencing (RNA-seq).

These methods comprise a step of sequencing a plurality of DNA samples from a chain of nucleotides, also called “sequenced chain”, to produce a plurality of sequence tags, also known as sequence reads. Said DNA samples are for example obtained by immunoprecipitation techniques like ChIP or MeDIP.

For example, according to the ChIP-seq method, which aims at determining the binding sites of a protein to a given chain of nucleotides, the DNA samples are produced by chromatin immunoprecipitation. Chromatin immunoprecipitation consists in cross-linking the protein of interest to the chain of nucleotides, in shearing the cross-linked chain of nucleotides into small fragments, in immunoprecipitating the protein, still bound to a chromatin fragment, using an antibody specific to the protein, and in reversing the cross-links to obtain the DNA samples.

The sequence reads are then mapped to the sequenced chain, i.e. are assigned to a particular position on this sequenced chain, to produce mapped reads, also called “total mapped reads” (or TMRs).

The sequenced chain is virtually split up into a plurality of distinct identified regions, which may each correspond to a particular locus on the sequenced chain or to a bin comprising a predefined number of base pairs.

The number of total mapped reads in each of these identified regions, called “read count intensity” or “RCI” is then counted.

The expression “original dataset” therefore refers to the computer dataset comprising the total mapped reads and the read count intensies computed from these total mapped reads for each distinct identified region of the sequenced chain.

The expression “sequencing depth” refers to the number of times a nucleotide is read during the sequencing process. The reachable sequencing depth notably depends on the NGS platform used for the sequencing, in particular on the sequencing capacities of this platform. The sequencing depth affects the total mapped reads obtained, and hence the read count intensities in the original dataset.

The invention will be better understood with reference to an exemplary embodiment of the invention which will now be described with reference to the appended figures wherein:

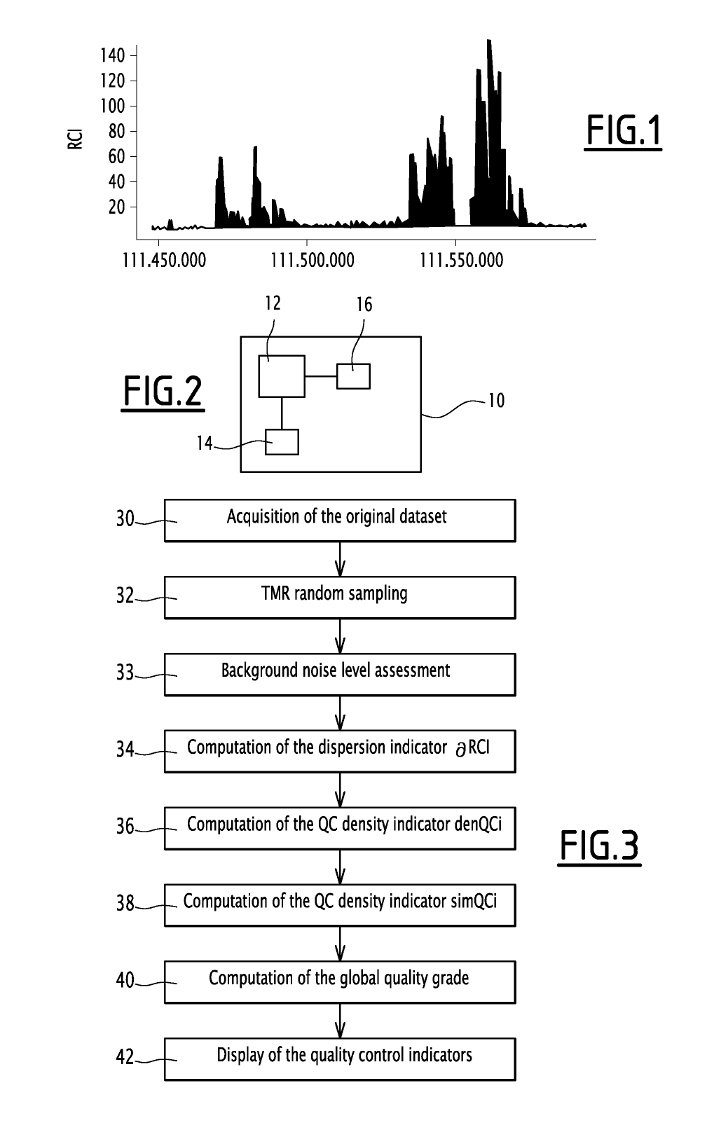

FIG. 1 is a graphic illustration of an original dataset,

FIG. 2 schematically illustrates an analysis system according to an embodiment of the invention;

FIG. 3 is a block diagram illustrating a method according to an embodiment of the invention;

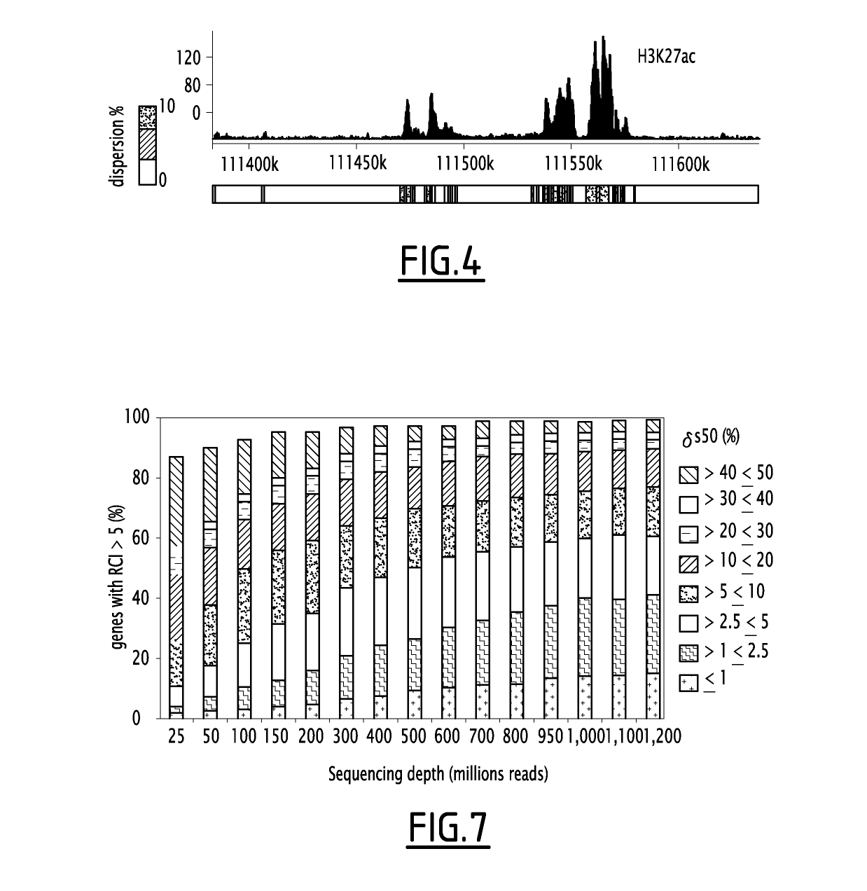

FIG. 4 shows a sequencing profile displayed together with the corresponding computed dispersion indicator;

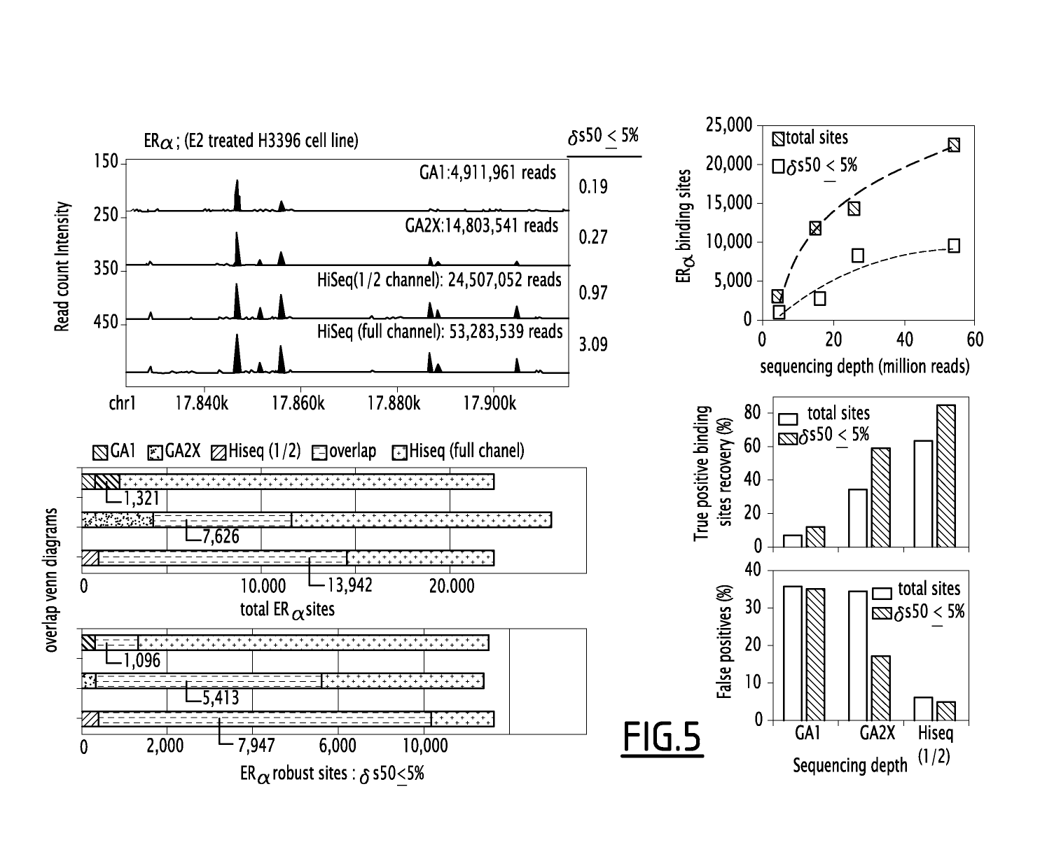

FIG. 5 illustrates the influence of the sequencing depths on the detection of Erα binding sites in H3396 breast cancer cells;

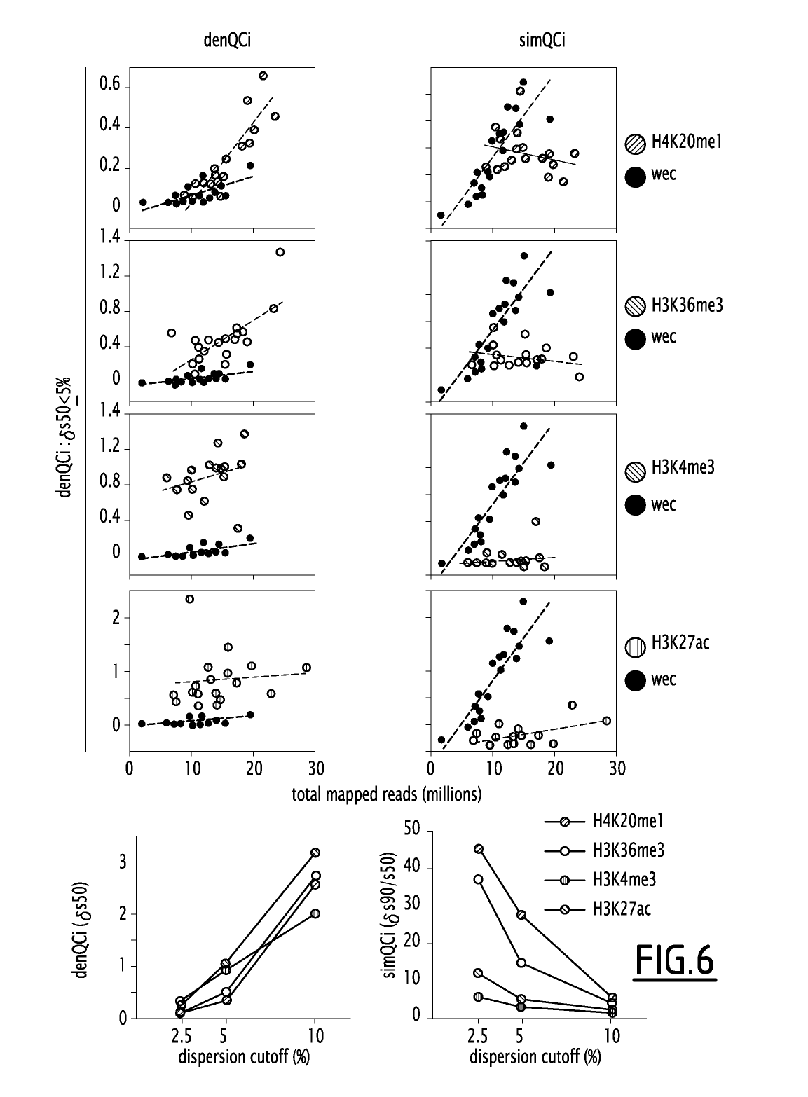

FIG. 6 illustrates several quality control indicators provided by the method according to the invention for several types of original datasets;

FIG. 7 illustrates the assessment of the robustness of RNA-seq assays at different sequencing depths;

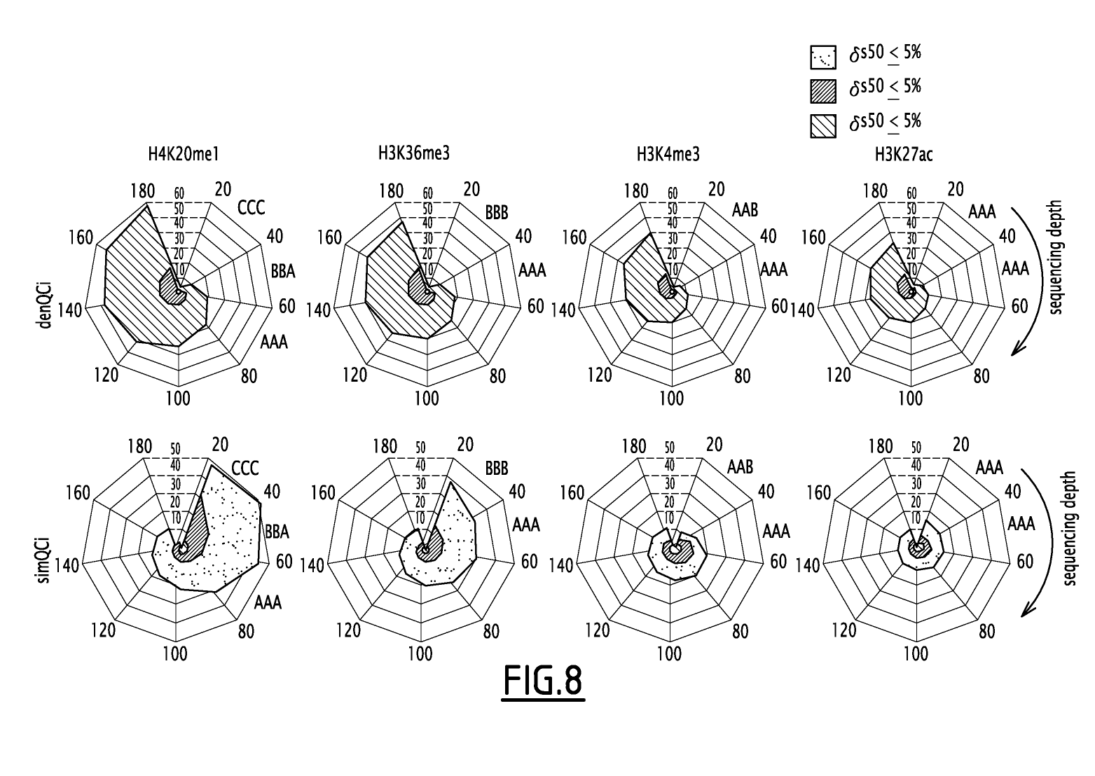

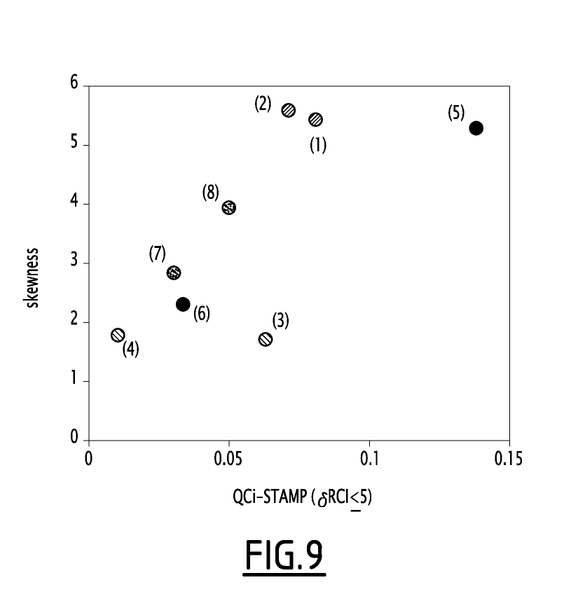

FIG. 8 illustrates the influence of the sequencing depth on the values of the density and similarity data provided by the method according to the invention;

FIG. 9 illustrates a comparison between the method according to the invention and signal distribution skewness;

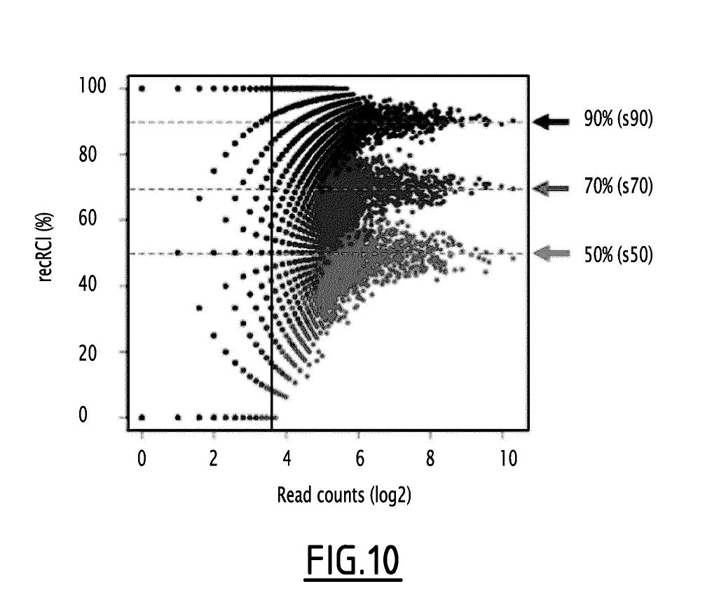

FIG. 10 is a scatter plot illustrating the background noise subtraction routine according to an optional aspect of the invention.

FIG. 1 is an example of graphic illustration of an original dataset whose quality and robustness may be assessed using the method according to the invention.

As previously described, the original dataset comprises total mapped reads (TMRs), obtained by mapping sequence reads to a sequenced chain. The sequenced chain comprises a plurality of predefined identified regions bₖ. The original dataset also comprises the read count intensity computed from these total mapped reads by calculating the number of total mapped reads in each predefined identified regions of the sequenced chain.

Hereafter, we will consider that the identified regions on the sequenced chain are bins comprising a predefined number of base pairs, for example 500 bp.

The original dataset therefore comprises a set of M total mapped reads, each associated to a location on the sequenced chain, and a set of N pairs (bₖ, oRCI(k))_{k=1,2, . . . , N}, wherein bₖ represents an identified region on the sequenced chain and oRCI(k) represents the read count intensity for this identified region bₖ, hereafter referred as “original profile”.

These data are shown in FIG. 1 in the form of a graph having oRCI(k) as a function of the location of region bₖ on the sequenced chain.

FIG. 2 shows a system 10 according to the invention, for the analysis of the quality and the robustness of an original dataset as described in reference to FIG. 1.

The system 10 comprises a processing unit 12, means 14 for inputting an original dataset into the processing unit 12, and a man/machine interface comprising means 16 for displaying said dataset and the quality control indicators computed from this dataset, in particular in graphic form.

The means 14 for inputting an original dataset into the processing unit 12 can enable the capture or transfer, automatically or by a user, of experimental data, toward the processing unit 12. For example, these input means 14 comprise an input peripheral such as a keyboard, and/or a digital media reader and/or a data input port.

The processing unit 12, connected to the input means 14 and to the display means 16, can analyze experimental data coming from the input means 14 and control the display of said data in graphic form by the display means 16.

The processing unit 12 comprises a suitable memory for storing data and a microprocessor.

The processing unit 12 is adapted to carry out the method according to the invention. In particular, the processing unit 12 is adapted to compute, from an original dataset, a set of global quality control indicators, and to provide local quality control indicators to judge the robustness of cumulative read counts in a particular region of the sequenced chain.

FIG. 3 shows the steps carried out by the system 10 shown in FIG. 2 to assess the quality and the robustness of an original dataset as described in reference to FIG. 1.

The method comprises an initialization step 30, wherein the original dataset is acquired by automated sequencing of a chain of nucleotides, and transferred to the processing unit 12, via input means 14.

The method relies on the determination of local quality control indicators each assessing the robustness of cumulative read counts in a particular region of the sequenced chain, by comparing distinct randomly sampled populations derived from the original dataset.

To that end, the method comprises a step 32 consisting in sampling the total mapped reads of the original dataset at a selected sampling density, to produce at least one data subset.

Preferably, the step 32 comprises the sampling of the total mapped reads at at least two distinct selected sampling densities, for example at three distinct selected sampling densities.

The sampling densities are for example chosen as 90%, 70% and 50%. Hereinafter, the sampling densities are denoted samdⱼ, samdⱼ being expressed as a percentage, and the associated data subsets are denoted sⱼ.

The step 32 therefore consists in randomly picking, for each sampling density samdⱼ, a subset of

$$M * \frac{{samd}_{j}}{100}$$

mapped reads from the set of M total mapped reads.

According to an optional aspect of the invention, the step 32 is followed by a step 33 wherein the system 10 applies a background noise subtraction routine in order to exclude background noises from each sampling. This routine is further detailed in this description.

The step 33 is followed by a step 34 wherein the system 10 evaluates, for each sampling density, the distribution of the sampled mapped reads in the identified regions of the sequenced chain to produce a sampled RCI profile, i.e. a set of N pairs (bₖ,samRCIₛⱼ(k))_{k-1,2 . . . . , N}, wherein samRCIₛⱼ(k) represents the actual read count intensity for the identified region bₖ in the sampled data subset sⱼ corresponding to the number of sampled mapped reads in this identified region for the current sampling.

The system 10 then compares the sampled RCI profile obtained for each sampling density to the original profile, to infer a local quality control indicator assessing the robustness of the read counts in each bin of the sequenced chain.

In the ideal case, the sampling of the total mapped reads should generate a sampled profile with the same distribution across the sequenced chain, but with a decrease of the read count intensities corresponding to the sampling density. The extent to which this reproducibility is attained is defined as “robustness” of the original RCI profile.

To assess the local robustness of the original RCI profile, the system 10 computes in step 34, for each bin at each sampling density, a dispersion indicator ∂RCI, representative of the divergence between the theoretical read count intensity which should be obtained in the ideal case and the actual read count intensity obtained for this bin at this sampling density subset.

The dispersion indicator ∂RcIₛⱼ(k) in a bin bₖ for a sampling subset sⱼ is computed by evaluating the variation of the read count intensity in the bin bₖ induced by the sampling, and by comparing this variation to the theoretical variation which should be induced.

The variation of the read count intensity in the bin bₖ induced by the sampling, denoted recRCIₛⱼ(k) and called hereafter recovered intensity, is for example expressed as a percentage comprised between 0 and 100 and computed as:

$${recRCI}_{sj} ( k ) = \frac{{samRCI}_{sj} ( k )}{oRCI ( k )} * 100.$$

As a consequence of the random sampling, the theoretical variation which should be induced by the sampling is equal to the sampling density samdⱼ.

Therefore, the dispersion indicator ∂RCIₛⱼ(k) is derived from recRCIₛⱼ(k) by computing the difference between recRCIₛⱼ(k) and the sampling density samdⱼ, as:

∂RCIₛⱼ(k)=samdⱼ−recRCIₛⱼ(k).

This dispersion indicator can equally be expressed as:

$$\partial {RCI}_{sj} ( k ) = {samd}_{j} [ 1 - \frac{{samRCI}_{sj} ( k )}{{theoRCI}_{sj} ( k )} ] wherein$$

$${theoRCI}_{sj} ( k ) = \frac{oRCI ( k ) * {samd}_{j}}{100}$$

is the theoretical read count intensity which should be obtained in bin bₖ at the sampling subset sⱼ, in the ideal case. The theoretical read count intensity does not depend on the current sampling.

The dispersion indicator ∂RCIₛⱼ(k) is therefore a percentage comprised between 0 and samdⱼ, the value 0 corresponding to an ideal local robustness, and the value samdⱼ corresponding to the lowest possible local robustness.

Thus, the “quality” is defined here as the degree of dispersion from the theoretically expected Read Count Intensities after sampling (theoRCI). With this definition a maximum of the quality control density indicator is reached when the recovered intensity per bin (recRCI/bin) values are equal to the original intensity RCI multiplied by the sampling percentage. Any deviation—for whatever reason—from the expected RCI/bin scatter provides a quantitative indicator of the quality of a given NGS-profile.

The system 10 then computes in a step 36 a quality control density indicator for each sampling data subset, denQCiₛⱼ, representative of a global robustness of the original dataset.

This quality control density indicator is determined on the basis of a comparison between the number of bins bₖ for which the dispersion indicator ∂RCIₛⱼ(k) is comprised within a given confidence interval, defined by a given maximal value, or threshold, with the total number of bins.

“Total number of bins” refers to the number of bins presenting at least one read in the original dataset.

For example, the step 36 comprises the determination of a confidence subset of bins for which the dispersion indicator ∂RCIₛⱼ(k) is lower than a given threshold, and the computation of the quality control density indicator denQCiₛⱼ as a ratio between the number of bins in this confidence subset and the total number of bins.

The quality control density indicator denQCiₛⱼ therefore equals the fraction of bins displaying a dispersion indicator δRCIₛⱼ(k) lower than the given threshold.

Preferably, the system 10 computes in step 36, for each sampling data subset samdⱼ, several quality control density indicators associated to several distinct given thresholds.

These given thresholds are for example equal to 2.5%, 5% and 10%.

The quality control density indicator denQCi computed for a given samples subset sⱼ and a given threshold t is noted δsj/t. For example, δs50/5represents the quality control density indicator computed for a sampling density of 50% and a threshold of 5%.

The quality control density indicator denQCi is a fraction comprised between 0 and 1, the global robustness of the original dataset increasing with the value of denQCi.

This step 36 is followed by a step 38 wherein the system 10 computes a quality control similarity indicator, simQCi, based on the comparison, for example the ratio, between the quality control density data computed in step 36 for two distinct sampling subsets sⱼ₁ and sⱼ₂, preferably for the same threshold t.

This quality control similarity indicator is referred to by the expression δsj1/sj2/t.

It is preferably computed as the ratio between the quality control density indicator δs90/5 for the sampling density 90% and the quality control density indicator δs50/5 for the sampling density 50%, for the threshold t=5%, as:

$$δ s 90 / s 50 / 5 = \frac{δ s 90 / 5}{δ s 50 / 5} .$$

The minimal theoretical value of quality control similarity indicator is 1.

This indicator is representative of the extent of similarity of the global robustness computed for the sampling subset s90, which is the closest subset to the original RCI profile, and the sampling subset s50, assessed from half of all the total mapped reads.

Indeed, the global robustness of a RCI profile may vary significantly with the chosen sampling density. Ideally, the quality control density indicator should be equal to 1 and not depend on the sampling, so that the density computed at 50% should be as close as possible to the quality control density indicator computed at 90%.

Therefore, the higher the quality control density indicator and the lower the similarity quality control indicator, the more robust is the evaluated RCI profile.

The method further comprises a step 40 of computing, for at least one given threshold t, a global quality grade representative of the robustness of the read count intensities in the original dataset as compared to other registered datasets.

This global quality grade is determined by computing at least one quality control stamp, noted QCi_STAMP, for at least one given threshold t, and by comparing this quality control stamp to a set of quality control stamps previously computed for a plurality of registered datasets.

These registered datasets are part of a preconstituted database of RCI profiles, stored in the memory of processing unit 12, or accessed to via the input means 14. For example, this database comprises the quality control analysis of more than 1,000 NGS datasets, including ChIP-seq profiles of histone modifications and variants, transcription factors, as well as GRO-seq and RNA-seq profiles.

For a given confidence interval t, the quality control stamp QCi_STAMP is based:
(i) on the quality control similarity indicator simQCi between two sampling subsets sᵢ and sⱼ, and
(ii) on the quality control density indicator denQCi of one the sampling subset sⱼ.

For example, the quality control stamp QCi_STAMP is computed as a ratio between said quality control similarity data simQCi and said quality control density indicator denQCi, as:

$$QCi\_STAMP = \frac{denQCi}{simQCi} = \frac{δ sj 2 / t}{δ sj 1 / sj 2 / t} .$$

Preferably, the sampling subsets sᵢ and sⱼ are chosen as s90 and s50.

Thence, the quality control stamp QCi_STAMP is computed for each threshold t as:

$$QCi\_STAMP = \frac{δ s 50 / t}{δ s 90 / s 50 / t}$$

For each threshold t, the value of the quality control stamp QCi_STAMP is compared to the values of “registered quality control stamps”, previously computed, for the same threshold, for each of the registered datasets, and the original dataset is assigned a global quality grade representative of the divergence of the quality control stamp QCi_STAMP over the registered quality control stamps.

According to a preferred embodiment, this comparison is carried out by the system 10 by subdividing the distribution of registered quality control stamps in several quantiles, each associated to a grade, and by determining in which of these quantiles the quality control stamp QCi_STAMP is comprised. The global quality grade assessed to the original dataset for the threshold t is then chosen as the grade associated to this quantile.

The higher the quantiles, the better are the grades associated to these quantiles. Indeed, as previously stressed, the higher the quality control density indicator denQCi and the lower the similarity quality control indicator simQCi, and consequently the higher the quality control stamp, the more robust is the evaluated RCI profile.

For example, the distribution of registered quality control stamps is subdivided in four quartiles, and the following grades are attributed: “D” for the first quartile (i.e. below 25%), “C” for the second (i.e. between 25% and 50%), “B” for the third quartile (i.e.between 50% and 75%) and “A” for the fourth quartile (i.e. above 75%).

Therefore, if a quality control stamp QCi_STAMP computed for the original dataset for the threshold t is comprised in the fourth quartile, this means that the robustness of this original dataset is good as compared to the registered datasets.

The quality control indicators depending on the chosen threshold, i.e. the quality control density indicator denQCi, the quality control similarity indicator simQCi and thence the quality control stamp QCi_{–}STAMP, do not necessarily vary linearly with the threshold t. Consequently, the global quality grade assessed to the original dataset for a threshold t does not necessarily prefigure the global quality grade which would be assessed for a different threshold.

Therefore, the step 40 preferably comprises the computation of three global quality grade, for three distinct thresholds t, for example 2.5%, 5% and 10%.

The robustness of the original dataset as compared to the database of registered datasets is assessed by three global quality grades.

These global quality grades are representative of the comparability of the original dataset with other datasets, as a concordance of the global quality grades associated to the original dataset with the global quality grades associated to another dataset mean that the robustness of these datasets are comparable.

Table 1 below shows a part of the database and the quality control indicators computed for each registered dataset of the database.

TABLE 1
Extract of the database of registered datasets

| Target | H3K9ac | H3K4me3 | H3K4me2 | H3K4me2 | H3K27ac |
|---|---|---|---|---|---|
| molecule | | | | | |
| Cell line | Huvec | HepG2 | HepG2 | K562 | HepG2 |
| Treatment | None | None | None | None | None |
| Genome | hg18 | hg18 | hg18 | hg18 | hg18 |
| TMRs | 9,675,720 | 10,007,440 | 1,4615,772 | 11,518,629 | 6,287,407 |
| Total bins | 3,370,359 | 1,677,429 | 2,921,562 | 3,491,766 | 2,159,641 |
| QCi-STAMP | AAB | AAA | AAA | AAA | AAA |
| ds90/2.5 | 1.60668344 | 4.18581055 | 4.63734810 | 2.78750065 | 2.21346974 |
| ds50/2.5 | 0.17953577 | 0.61218687 | 0.39584989 | 0.17111685 | 0.18896659 |
| ds90/s50/2.5 | 8.94909932 | 6.83747200 | 11.71491569 | 16.29004184 | 11.71355060 |
| ds90/5 | 2.95728141 | 7.09878034 | 8.54881738 | 5.50062633 | 4.17675901 |
| ds50/5 | 0.75932564 | 2.29762333 | 1.98424678 | 0.92397371 | 0.87871086 |
| ds90/s50/5 | 3.89461551 | 3.08961885 | 4.30834383 | 5.95322816 | 4.75328029 |
| ds90/10 | 4.01808828 | 9.00187132 | 11.27701551 | 7.65331927 | 5.61463688 |
| ds50/10 | 1.99067814 | 5.17285680 | 5.81079573 | 3.26751564 | 2.67461120 |
| ds90/s50/10 | 2.01845200 | 1.74021274 | 1.94070073 | 2.34224412 | 2.09923479 |

Table 2 below sums up some experiments associated to the datasets of the database, as well as the number of total mapped reads in these datasets and the global quality grades derived from the values of denQCi and simQCi for each dataset, for the thresholds 2.5%, 5% and 10%.

TABLE 2
Quality grades assigned to several datasets

| | | Quality Grade |
|---|---|---|
| Target ID | TMRs | (t = 2.5%-5%-10%) |
| RNA-seq | 10,285,026 | AAA |
| H3K9ac | 9,675,720 | AAA |
| H3K4me3 | 10,007,440 | AAA |
| H3K4me2 | 14,615,772 | AAA |
| H3K9ac | 11,991,828 | BBC |
| H3K9ac | 11,950,657 | BCC |
| H4K20me1 | 21,552,590 | BBB |
| H3K9ac | 17,560,679 | BCC |
| H3K4me3 | 23,146,665 | BCB |
| CTCF | 23,211,599 | BBB |
| WCE | 19,637,643 | CDD |
| WCE | 8,410,101 | DDD |
| WCE | 7,599,303 | DDD |

In this example, the registered quality control stamps are distributed in four quartiles and the grades A, B, C or D associated to the datasets depending on the value of their quality control stamp. The first letter reveals this position for a δRCI dispersion threshold of 2.5%, the second and third letter for 5% and 10% δRCI, respectively.

The registered datasets includes ChIP-seq profiles of histone modifications and variants, transcription factors, as well as GRO-seq and RNA-seq profiles.

As an example, the H3K4me3 profile derived from 10,007,440 TMRs is classified as “triple A” profile, while non-enriched WCE profiles are, as expected, of the lowest possible quality, “triple D”.

Similarly expected was the high QC performance of RNA-seq, which does not involve the complex experimentation and IP procedures as ChIP-seq, and consequently received “triple A” rating.

Note that these ratings are meant to provide a simplified view of the evaluated profile's robustness but not to replace the control quality indicators, which provide more specific information.

As the quality of a ChIP-seq profile is the direct consequence of a rather large number of factors (e.g. crosslinking efficiency, chromatin shearing, antibody affinity and selectivity, variability between experiments, experimenters, and platforms), the quality control indicators cannot per se identify the source for the bad quality of a given profile.

However, it does allow identification of datasets of divergent quality, which cannot be compared with each other, even though they might have been generated under similar conditions. Importantly, in contrast to current practice, the sequencing depth applied for generating NGS-profiles is a parameter which may be adjusted to generate profiles of similar quality.

The method further comprises a step 42 of a displaying, on the man/machine interface of the system 10, the quality control indicators computed from the original dataset, in particular in graphic form, as illustrated in reference to FIGS. 4-10.

For example, the system 10 displays scatter plots of the read count intensities obtained after sampling as compared to the read count intensities in the original dataset, each data point on the scatter plots corresponding to the read count intensity within a 500 bp bin (x-axis) relative to the fraction of this intensity, i.e. the recovered intensity, which is recovered after random sampling (y-axis).

This type of scatter plot provides intuitive information about the quality of the generated profile. In fact, profiles of good quality show high number of bins that display a proportional decrease of read count intensity/bin in the sampled subsets compared to the original dataset. Thus, the less dispersed the recRCI pattern is, the better is the quality of the associated profile.

FIG. 4 illustrates how the dispersion indicator ∂RCI can be displayed in a heatmap format linked to the original read count intensity profile (H3K27ac ChIP-seq profile).

Below the ChIP-seq profile the corresponding ∂RCI for each 500 bp bin are displayed for a 10% threshold using the heat map illustration indicated on the left. Only bins with ∂RCI≦10% are shown.

This display is useful to visualize the ∂RCI associated to a given chromatin region of interest.

FIG. 5 illustrates how the method according to invention allows the assessment of the influence of the sequencing depths on the detection of Erα binding sites in E2 treated H3396 breast cancer cells.

As previously described, the total mapped reads used for profile reconstruction can vary dramatically, inducing questions concerning the comparability of profiles that were constructed with different amounts of TMRs.

FIG. 5—top left illustrates several ERα read count intensity profiles obtained from different sequencing platforms, i.e. Illumina Genome Analyser 1 (GA1), Genome Analyser IIx (GA2X) and Hiseq2000.

Each of the displayed ChIP-seq profiles was obtained by sequencing a single channel of the corresponding platform except for Hiseq2000, where half a channel or a full one was used. The corresponding mapped reads and their associated denQCi (δs50≦5%) are displayed.

The sequencing depths provided by the different sequencing platforms correlate well with the overall read count intensities. Importantly, TMR sampling analysis revealed a 16.2-fold increase of denQCi (δs50≦5%), and thus, global profile “robustness”, with increased sequencing depth.

FIG. 5—top right illustrates the total ERα binding sites identified in the ChIP-seq profiles shown on top left FIG. 6, compared with those that complied with the δs50≦5% criterion. ERα binding sites were predicted with MeDiChI (FDR adjusted p-values threshold 10^{-4.5}).

The number of TMRs used for ERα profile construction strongly influenced the total number of predicted statistically significant binding sites. In fact, with more than 50 million reads for the Hiseq2000 profile, 22,150 ERα sites were predicted. In contrast only 2,038 sites were predicted from ˜5 million reads obtained with one GA1 channel.

Although the total number of predicted peaks increased strongly with increasing sequencing depths, the number of sites that complied with δs50≦5% shows a much slower increase and entered a plateau phase above 24 million TMRs. This indicates that the “robust” ERα binding sites approach saturation.

FIG. 5—center left represents two Venn-diagrams illustrating overlap and outlier populations for ERα binding sites retrieved from sequencing a full HiSeq2000 channel compared with those identified at lower sequencing depths. This analysis was performed for total ERα sites (top panels) and those complying with δs50≦5% (bottom panels).

When comparing the ERα binding sites predicted at highest sequencing depth with those derived from the other profiles, not only the number but also the robustness of peaks in the overlapping population increase with increasing sequencing depth. From 1,321 ERα sites in the overlap between GA1 and the full channel HiSeq2000 profile, more than 80% of them (1,096 sites) comply with δs50≦5%.

Similarly, the number of ERα binding sites overlapping with the GA2X or half channel HiSeq2000 datasets increase strongly over that obtained with GA1, as does the number of robust peaks.

As ERα binding sites were profiled under identical treatment conditions, it was reasonable to assume that the sites identified at low sequencing depth constitute a subpopulation of those identified in the high TMR profiles.

This comparison also reveals a significant number of non-overlapping sites. While it is reasonable to assume that the outliers of the HiSeq2000 profile result from the incomplete binding sites recovery from the other profiles, those outliers that are seen in the low TMR profiles but not in the HiSeq2000 are likely “false positives”. Indeed, the number of such sites is variable and does not follow a common trend as does the increase of the overlap population with increasing sequencing depth; in this respect the GA2X dataset is sub-optimal with 4 to 5-times more outliers that the GA1 and ½Hiseq ones.

FIG. 5—center right illustrate the fraction of true sites (considered as the sites identified with the full HiSeq2000 channel) recovered in the compared profiles (top panel), as well as the false calls, estimated from the outlier population (bottom panel).

Note the increase of true sites and a concomitant decrease of false calls in the population that complies with δs50≦5%.

In particular, the number of true ERα binding sites increase from less than 5% for the GA1 dataset to about 60% for the half channel HiSeq2000 profile. Importantly, 80% “true positive” binding sites were recovered when only robust ERα sites are considered, thus showing that applying the denQCi criterion helps to identify the highly reliable sites when comparing ChIP-seqs with largely differing sequencing depths.

FIG. 6—top displays quality control density indicators denQCis (δs50/5) and quality control similarity indicators simQCis (δs90/50/5) for four ChIP-seq profiles in the context of their total mapped reads.

The panel illustrates denQCis and simQCis for H4K20me1, H3K36me3, H3K27ac and H3K4me3 ChIP-seq profiles. In addition, denQCis and simQCis for a non-enriched input dataset (whole cell extract, WCE) are illustrated for comparative purposes.

This figure show that the quality control indicators can vary dramatically between experiments, depending notably on the sequencing depth.

In particular, the comparison of several H4K20me1 profiles demonstrates that at least 15 million total mapped reads are required to obtain quality control indicators that differentiate between the ChIP-derived and the non-enriched datasets. Indeed, comparing the quality control indicators for several H4K20me1 datasets generated from largely different TMRs reveals that below 15 million TMRs the quality control indicators become indistinguishable from the WCE profiles, strongly arguing that significantly higher sequencing depths are essential to establish accurate profiles for such targets.

In contrast, H3K4me3 ChIP-seq profiles present fairly good quality control indicators even for TMRs lower than 15 million reads.

Therefore, in addition to revealing quality differences between datasets for different targets at similar total mapped reads, the quality control indicators according to the invention also provide important quality information about datasets for the same target at different sequencing depths.

Importantly, in the four profiles, individual ChIP-seq profiles can be observed which have been performed at similar sequencing depths but data analysis reveals nevertheless greatly varying global quality control indicators. This underscores the notion that in addition to the sequencing depth, (multiple) other factors, whose effects cumulate along the experimental path towards to final data set, influence the quality of the profile.

Other histone modification profiles reconstructed from similar or even lower total mapped reads displayed better quality control indicators than either H4K20me1 or WCE, thereby revealing that the robustness of a profile depends not only on the sample preparation and sequencing depth but also on the nature of the immuno-precipitated target.

FIG. 6—bottom displays density and similarity quality control indicators at stringent (δs50≦2.5%), intermediate (δs50≦5%) and relaxed (δs50≦10%) dispersion intervals, for the H4K20me1, H3K36me3, H3K27ac and H3K4me3 ChIP-seq profiles.

This figure illustrates the fact that the quality control indicators determined for different thresholds do not necessarily show a linear relationship, hence the relevance of the quality control quality stamp.

FIG. 7 illustrates the assessment of the robustness of RNA-seq profiles at different sequencing depths.

While RNA-seq is increasingly used to quantify relative gene expression at genome-wide levels, the impact of variable sequencing depths on the accuracy of gene expression measurements has only been recently addressed.

Poly(A)+RNA-seq (mRNA-seq) datasets from cultured human B-cells were downloaded from GEO (GSE29158). In order to study the influence of the sequencing depth on the profile robustness, datasets were pooled to generate a main dataset containing about 1.2 billion TMRs (for 32,553 genes). Fifteen randomly sampled subsets comprising 25 million to 1.2 billion TMRs were generated. For each of them the corresponding global and local quality control indicators (δRCI, denQCI) were computed according to the invention and this information was used to infer the median RCI dispersion per ref-seq annotated coding region.

FIG. 7 shows, for each evaluated sequencing depth transcripts, the proportion of genes such that their median dispersion, δs50/t, t varying from 1% to 50% (grey scale on the right), is equal to more than 5%.

Note that the expression of more than 95% of all annotated genes can be monitored with 150 million TMRs but only 30% comply with a median δs50≦5%.

Importantly, the fraction of robust genes bypasses 50% for TMRs higher than 500 millions. Moreover, at 150 million TMRs, about 15% of the transcripts displayed a dispersion δs50 above 40% (δs50/40=85%).

Increasing the TMRs above 500 millions reduce these low quality fraction to less than 5%.

This analysis strongly suggests that an increase of the sequencing depth not only favors the detection of new transcripts but most importantly, improves the robustness associated with the identified genes. Importantly, the evaluation of RNA-seq profile robustness reveals the fraction of transcripts displaying the highest quality at a given sequencing depth, which is an essential parameter that needs to be considered when quantifying differential gene expression.

FIG. 8 shows several plots illustrating the influence of the sequencing depth on the density (top row) and similarity (bottom row) quality control indicators. This analysis was performed by compiling several profiles and subsequently sampled at defined TMRs ranging from 20 to 180 million.

For each re-sampled subset the corresponding control quality indicators were computed and displayed in spider-web charts, in which denQCi and simQCi are displayed for different δRCI thresholds (2.5%, 5% and 10%).

QC-STAMPs have been associated to the evaluated profiles as illustrated.

Note that for H4K20me1 sequencing depths of up to 60 million reads are required to obtain a “triple A” grade, while H3K27ac and H3K4me3 receive this grade with 20 million TMRs.

Moreover, for similar total mapped read levels, H4K20me1 or H3K36me3 profiles display in general poorer quality than those of H3K27ac or H3K4me3. However, increasing the sequencing depth will improve their quality descriptors to attain comparable levels, such that, for example, only “triple A” datasets can be compared.

In this respect, the database allows a priori predictions of the minimal sequencing depth required for a given target to reach a pre-defined quality.

A comparison between signal distribution skewness, which appears to be the only other universal quality measurement method, and the method according to the invention was performed by evaluating the degree of skewness in four publicly available CTCF ChIP-seq datasets (each of them represented by two biological replicates) and comparing it with the quality control stamps

$$QCi\_STAMP = \frac{δ s 50 / t}{δ s 90 / s 50 / t}$$

for these datasets.

These datasets and the quality grades associated to these datasets are summarised in Table 3 below.

TABLE 3
Quality grades assigned to several datasets (2)

| | Quality grade |
|---|---|
| Dataset | (t = 2.5%-5%-10%) |
| (1) CTCF-GSM646455 | BBB |
| (2) CTCF-GSM646454 | BBB |
| (3) CTCF-GSM646373 | BBB |
| (4) CTCF-GSM646372 | CCC |
| (5) CTCF-GSM646335 | AAB |
| (6) CTCF-GSM646334 | BBC |
| (7) CTCF-GSM646315 | BBC |
| (8) CTCF-GSM646314 | BBC |

FIG. 9 shows the comparison between the quality control stamps for t=5% and the degrees of skewness computed for these datasets.

Importantly, both methods provide very similar quality predictions, with the important exception that the difference in quality of one pair of the evaluated replicates (GSM646372 and GSM646373 datasets) was predicted by the quality control stamp QCi-STAMP but not by the skewness analysis.

These comparisons show that the quality control stamp indicator QCi-STAMP and the quality grade provide a more versatile and reliable quality discrimination of NGS-generated profile than the skewness approach.

The method according to the invention evaluates robustness directly from the raw pattern of genome-aligned reads. Therefore, quality control indicators can be established for any type of NGS-generated profile, including ChIP-seq, RNA-seq, GRO-seq and others, making this method a universal tool for multidimensional quality profile comparison.

According to an optional aspect of the invention, the method for processing data is improved by using the background noise subtraction routine of step 33.

The background noise distribution in any original dataset is modelled by using a Poisson distribution, from which the probability of having a given RCI due to random read enrichment is predicted.

The noise subtraction routine firstly determines the Poisson parameter λ which is, for example, a function of the number M of total mapped reads TMRs and the number N of identified regions bₖ.

Then, the noise subtraction routine infers a background noise level threshold value associated to a given probability threshold (for instance p=0.995) from the cumulative Poisson distribution function. This threshold value is noted bgRCI^{p-0.995}.

Finally, the noise subtraction routine excludes any region bₖ presenting RCIs lower or equal to bgRCI^{p-0.995} from the subsequent steps involved in the assessment of the quality descriptors.

FIG. 10 shows a scatter plot illustrating the recovered read count intensity recRCI of a given original dataset after random sampling with 90, 70 and 50% sampling densities.

On this figure, the vertical line corresponds to the background noise level threshold value bgRCI^{p-0.995}. Thus, the regions bₖ corresponding to the plurality of points comprised between 0 and bgRCI^{p-0.995} are excluded from the quality analysis.

1. Method for processing data for evaluating a quality level of an original dataset resulting from an automated sequencing of a chain of nucleotides, wherein said sequenced chain comprises a plurality of predefined identified regions and said original dataset represents a plurality of total mapped reads and a plurality of read count intensities, each read count intensity corresponding to the number of total mapped reads in an identified region of said sequenced chain,
said method comprising:
sampling of the plurality of total mapped reads of said original dataset at a selected sampling density to produce at least one data subset comprising a plurality of sampled mapped reads;
for each said data subset, computing at least one dispersion indicator for each of said identified regions, representative of the divergence between an actual read count intensity for said identified region in said data subset and a theoretical read count intensity for said identified region in said data subset, the actual read count intensity for said identified region corresponding to the number of sampled mapped reads in this identified region, the theoretical read count intensity for said identified region corresponding to a theoretical number of sampled mapped reads in this identified region which does not depend on the current sampling.

2. Method according to claim 1, wherein said theoretical read count intensity is computed on the basis of the read count intensity for said identified region in said original dataset and on the basis of said selected sampling density.

3. Method according to claim 2, wherein said theoretical read count intensity is computed as:
$$theoRCI = \frac{oRCI * samd}{100} ,$$
wherein:
theoRCI designates said theoretical read count intensity for said identified region in said original dataset,
samd designates said selected sampling density, expressed as a percentage between 0 and 100,
oRCI represents the read count intensity for said identified region in said original dataset.

4. Method according to claim 3, wherein said dispersion indicator for an identified region is computed as:
$$\partial RCI = samd [ 1 - \frac{samRCI}{theoRCI} ] = samd - recRCI$$
$$with recRCI = \frac{samRCI}{oRCI} * 100 ,$$
wherein:
∂RCI designates said dispersion indicator, and
samRCI represents the actual read count intensity for said identified region in said data subset.

5. Method according to claim 1, wherein said or each data subset is produced by randomly sampling said original dataset.

6. Method according to claim 1, further comprising:
determining a confidence subset of said identified regions for which the dispersion indicator is comprised within a given confidence interval, defined by a given maximal value,
computing a quality control density indicator representative of the robustness of said original dataset, on the basis of a comparison between the number of said identified regions in said confidence subset with the total number of identified regions.

7. Method according to claim 6, wherein said quality control density indicator is computed as a ratio between the number of said identified regions in said confidence subset and the total number of identified regions.

8. Method according to claim 6, wherein said method comprises the sampling of said original dataset for producing at least a first and a second data subsets according to two distinct selected sampling densities and the computation, for each of said first and second data subsets, of the or each dispersion indicator for each identified region.

9. Method according to claim 8, wherein said method further comprises the step of computing a quality control similarity indicator based on the comparison between a quality control density indicator of said first subset based on a first given confidence interval and a quality control density indicator of said second subset based on a second given confidence interval.

10. Method according to claim 9, wherein said first given confidence interval is identical to said second given confidence interval, and in that said quality control similarity indicator is computed as a ratio between the quality control density indicator of said first subset and the quality control density indicator of said second subset.

11. Method according to claim 9, further comprising:
computing, for at least one given confidence interval, a quality control stamp based on:
(i) the quality control similarity indicator between said first and second data subsets, and
(ii) the quality control density indicator of said second data subset.

12. Method according to claim 11, wherein said control quality stamp is computed as a ratio between the quality control density indicator of said second data subset and the quality control similarity indicator between said first and second data subsets.

13. Method according to claim 11, comprising:
computing, for at least one given confidence interval, a quality grade representative of the robustness of the read count intensities in said original dataset as compared to a plurality of distinct datasets, said quality grade being based on a comparison between the quality control stamp associated with said original dataset for said given confidence interval and a set of quality control stamps associated with said plurality of distinct datasets for said given confidence interval.

14. Method according to claim 1, further comprising:
determining of a background noise level threshold value in the original dataset by using a given probability threshold;
excluding any identified region presenting a read count intensity lower or equal to the background noise level threshold value.

15. System for processing data for evaluating a quality level of an original dataset resulting from an automated sequencing of a chain of nucleotides, wherein said sequenced chain comprises a plurality of predefined identified regions and said original dataset represents a plurality of total mapped reads and a plurality of read count intensities, each read count intensity corresponding to the number of total mapped reads in an identified region of said sequenced chain,
Said system comprising:
a sampler for sampling the plurality of total mapped reads of said original dataset at a selected sampling density to produce at least one data subset comprising a plurality of sampled mapped reads;
a computer for computing, for each said data subset, at least one dispersion indicator for each of said identified regions, representative the divergence between an actual read count intensity for said identified region in said data subset and a theoretical read count intensity for said identified region in said data subset, the actual read count intensity for said identified region corresponding to the number of sampled mapped reads in this identified region, the theoretical read count intensity for said identified region corresponding to a theoretical number of sampled mapped reads in this identified region which does not depend on the current sampling.
